(19) United States
(12) Patent Application Publication
(10) Pub. No.: US 2024/0311400 A1
(43) Pub. Date: Sep. 19, 2024

(54) TRAFFIC RESTRICTION IDENTIFICATION METHOD AND ELECTRONIC DEVICE

(71) Applicant: BEIJING BAIDU NETCOM SCIENCE TECHNOLOGY CO., LTD., Beijing (CN)

(72) Inventors: Qiulin Chen, Beijing (CN); Jiachen Dong, Beijing (CN)

(73) Assignee: BEIJING BAIDU NETCOM SCIENCE TECHNOLOGY CO., LTD., Beijing (CN)

(21) Appl. No.: 18/044,340

(22) PCT Filed: Feb. 25, 2022
(86) PCT No.: PCT/CN2022/077948

§ 371 Date: Mar. 7, 2023

(30) Foreign Application Priority Data
Sep. 30, 2021 (CN) 202111168089.9

(51) Int. Cl. G06F 16/29

(52) U.S. Cl. CPC G06F 16/29

(57) ABSTRACT

A traffic restriction identification method includes: determining prohibition marking lines based on lane-level data; determining a first lane group corresponding to a longitudinal prohibition marking line included in the prohibition marking lines; determining a second lane group and a third lane group adjacent to the first lane group based on the first lane group and the longitudinal prohibition marking line; and determining whether a path-level traffic restriction exists based on a connectivity of the first lane group with the second lane group and the third lane group.

### CROSS-REFERENCE TO RELATED APPLICATION

This application is based on and claims priority to Chinese Patent Application No. 202111168089.9, filed on Sep. 30, 2021, the entire contents of which are incorporated herein by reference.

### FIELD

The present disclosure relates to the technical field of intelligent transportation, and especially, to a traffic restriction identification method, a traffic restriction identification apparatus, and an electronic device in the technical field of electronic map navigation.

### BACKGROUND

With the enhancement of transportation infrastructure and the increase of vehicles on roads, the application of a navigation device in vehicle travel has become more and more extensive. The navigation device performs path planning and path recommendation according to an electronic map. However, since the electronic map does not support the identification and recording of ground marking lines, the ground marking lines need to be identified and recorded manually. Therefore, the update of path-level traffic restriction information is not timely. Therefore, how to efficiently identify traffic restriction information is the goal that has been pursued in the field of intelligent transportation.

### SUMMARY

The present disclosure provides a traffic restriction identification method, a traffic restriction identification apparatus, and an electronic device.

According to a first aspect of the present disclosure, there is provided a traffic restriction identification method. The method includes: determining prohibition marking lines based on lane-level data, determining a first lane group corresponding to a longitudinal prohibition marking line included in the prohibition marking lines, determining a second lane group and a third lane group adjacent to the first lane group based on the first lane group and the longitudinal prohibition marking line, and determining whether a path-level traffic restriction exists based on a connectivity of the first lane group with the second lane group and the third lane group.

According to a second aspect of the present disclosure, there is provided a traffic restriction identification apparatus. The apparatus includes: a prohibition marking line determining module configured to determine prohibition marking lines based on lane-level data, a lane group determining module configured to determine a first lane group corresponding to a longitudinal prohibition marking line included in the prohibition marking lines, and determine a second lane group and a third lane group adjacent to the first lane group based on the first lane group and the longitudinal prohibition marking line, and a traffic restriction determining module configured to determine whether a path-level traffic restriction exists based on a connectivity of the first lane group with the second lane group and the third lane group.

According to a third aspect of the present disclosure, there is provided an electronic device. The electronic device includes at least one processor, and a memory communicatively connected to the at least one processor. The memory is stored with instructions executable by the at least one processor, and the instructions, when executed by the at least one processor, cause the at least one processor to perform the above-mentioned traffic restriction identification method.

According to a fourth aspect of the present disclosure, there is provided a non-transitory computer-readable storage medium having stored therein computer instructions that cause a computer to perform the above-mentioned traffic restriction identification method.

According to a fifth aspect of the present disclosure, there is provided a computer program product including a computer program/instruction that, when executed by a processor, causes the above-mentioned traffic restriction identification method to be implemented.

It is to be understood that what is described in this section is not intended to identify key or important features of embodiments of the present disclosure, nor is it intended to limit the scope of the present disclosure. Other features of the present disclosure will be readily understood through the following description.

### BRIEF DESCRIPTION OF THE DRAWINGS

The accompanying drawings are used for a better understanding of the present solution and do not constitute a limitation of the present disclosure, in which

FIG. 1 is a schematic diagram showing prohibition marking lines provided by the present disclosure;

FIG. 2 is a schematic diagram showing a road provided by an embodiment of the present disclosure;

FIG. 3 is a schematic diagram showing a road connection structure provided by an embodiment of the present disclosure;

FIG. 4 is a flow chart showing a traffic restriction identification method provided by an embodiment of the present disclosure;

FIG. 5 is a schematic diagram showing a longitudinal prohibition marking line provided by an embodiment of the present disclosure;

FIG. 6 is a schematic diagram showing another road provided by an embodiment of the present disclosure;

FIG. 7 is a schematic diagram showing a second lane group and a third lane group provided by an embodiment of the present disclosure;

FIG. 8 is a schematic diagram showing another road connection structure provided by an embodiment of the present disclosure;

FIG. 9 is a schematic diagram showing a traffic restriction path provided by an embodiment of the present disclosure;

FIG. 10 is a schematic diagram showing a traffic restriction identification apparatus provided by an embodiment of the present disclosure; and

FIG. 11 is a block diagram showing an electronic device used to implement a traffic restriction identification method according to an embodiment of the present disclosure.

### DETAILED DESCRIPTION

Illustrative embodiments of the present disclosure are described below with reference to the accompanying drawings, in which various details of embodiments of the present disclosure are included to facilitate understanding, and they should be regarded as illustrative merely. Therefore, those skilled in the art should realize that various changes and modifications may be made to embodiments described herein without departing from the scope and spirit of the present disclosure. Also, descriptions of well-known functions and structures are omitted from the following description for clarity and conciseness.

In the following description, reference is made to “some embodiments” which describe a subset of all possible embodiments, but it is understood that “some embodiments” may be the same or a different subset of all possible embodiments, and may be combined with each other without conflict.

In the following description, the terms “first\second\third” are only used to distinguish similar objects, and do not represent a specific ordering of the involved objects. It is understood that a specific sequence of the terms “first\second\third” may be interchanged if permitted, so that embodiments of the present disclosure described herein may be practiced in sequences other than those shown or described herein.

Unless defined otherwise, all technical and scientific terms used herein have the same meaning as commonly understood by one of ordinary skill in the art to which the present disclosure pertains. Terms used herein are only for the purpose of describing embodiments of the present disclosure, but are not be construed to limit the present disclosure.

The terms involved in embodiments of the present disclosure are briefly described before describing the traffic restriction identification method provided by embodiments of the present disclosure.
1) Lane-level data refers to data related to a lane. The lane-level data may include one or more of lane center lines, lane boundary lines, lane edge lines, and lane turning signs.
2) A longitudinal prohibition marking line is configured to indicate an impassable line in a direction in which a vehicle is traveling.
3) A lane group is a collection of one or more lanes, and includes lane boundary lines and lane center lines of the one or more lanes in the lane group.
4) The lane boundary line refers to a ground marking line, including a longitudinal lane marking line and a transverse lane marking line according to a drawing direction. The longitudinal lane marking line is a marking line used to separate a traffic flow of vehicle driving lanes. The transverse lane marking line is a traffic marking line perpendicular to a direction of vehicle travel, such as transverse deceleration signs and stop signs.
5) The lane center line is a theoretical center line of a lane, which is used to represent an ideal driving line of the vehicle in the lane.
6) A lane refers to an area on the road that is divided according to the lane boundary line for vehicles to travel.
7) A path-level traffic restriction refers to passing restriction of a path formed by some links.
8) A link, in an electronic map, is a basic unit of a line. The line is represented by a sequence of links. In electronic map data, the road is divided into line segments, lengths of these line segments vary from tens of meters to thousands of meters, each line segment is referred to as a link, and each link may be given a globally unique identifier (ID). A line in the electronic map data is represented by a sequence of links in the line.
9) The electronic map, also referred to as a digital map, is a map that is stored and consulted digitally by using computer technology.

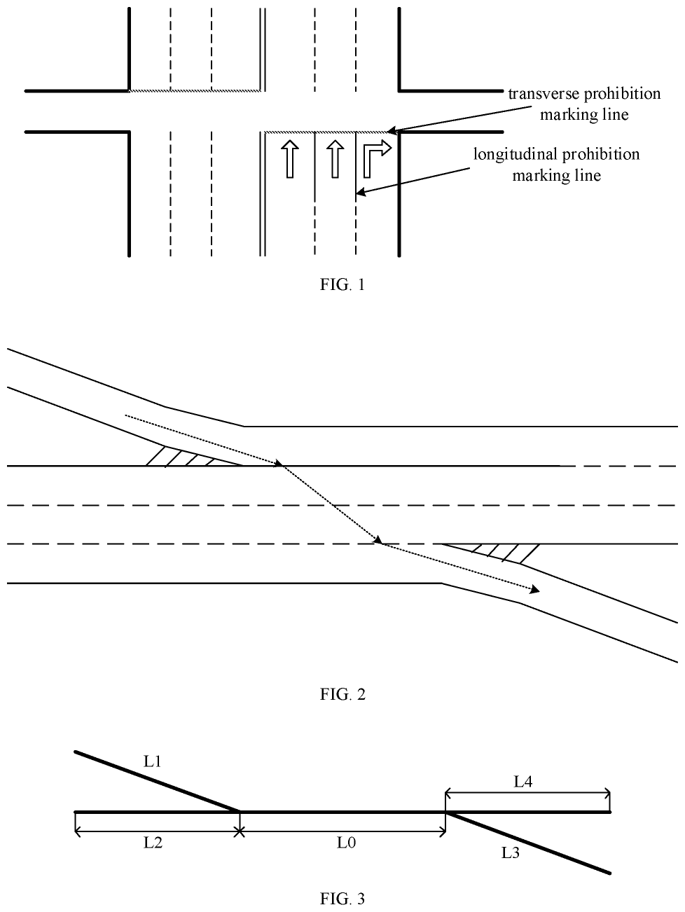

In the related art, path-level traffic restriction information is related to a control range of prohibition marking lines (also referred to as road prohibition marking lines). A schematic diagram of the prohibition marking lines is shown in FIG. 1. The prohibition marking lines include longitudinal prohibition marking lines and transverse prohibition marking lines. When a longitudinal prohibition marking line controls two or more intersections, it indicates that there is a path-level traffic restriction, and vehicles cannot cross the longitudinal prohibition marking line in the form of a solid line to drive into other lanes.

The present disclosure provides a schematic diagram of a road, as shown in FIG. 2, there is a single solid line at a boundary between two adjacent roads, so vehicles are prohibited from driving along a path indicated by the arrow in FIG. 1, and the path indicated by the arrow is a traffic restriction path. The road shown in FIG. 1 may be represented as a road connection structure shown in FIG. 3. According to the road connection structure shown in FIG. 2 and the path indicated by the arrow in FIG. 1, it may be determined that a path from a link L1 through a link L0 to a link L3 forms a path-level traffic restriction. That is, vehicles cannot travel from the link L1 to the link L3 via the link L0.

If the path-level traffic restriction in FIG. 1 is not updated in time, the electronic map cannot identify the path-level traffic restriction when planning a path for a user, so that in the path planned by the electronic map for the user, there may be a path-level traffic restriction formed by the links L1-L0-L3, which may lead the user to violate traffic law and regulation, or the user finds that there is a path-level traffic restriction in the path planned by the electronic map when driving to the link L1, so the user needs to re-plan a path, which affects the user's experience.

The present disclosure provides a traffic restriction identification method, which may determine path-level traffic restrictions according to prohibition marking lines without manually updating path-level traffic restrictions periodically, thereby not only saving manpower, but also improving the efficiency of updating the path-level traffic restrictions.

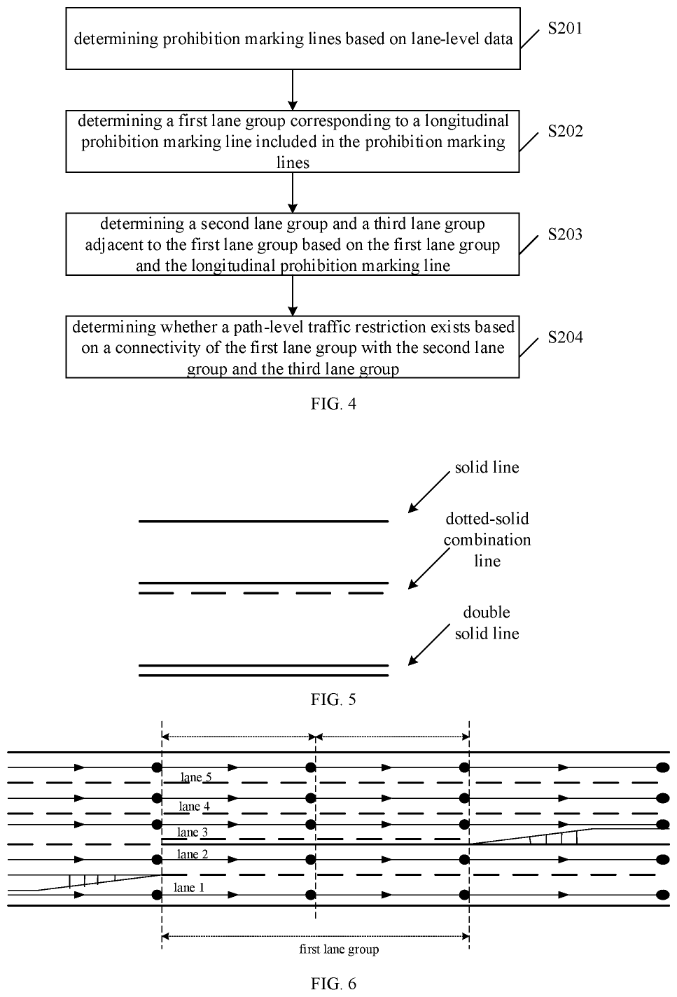

FIG. 4 is a flow chart showing a traffic restriction identification method provided by an embodiment of the present disclosure. The traffic restriction identification method may at least include steps S201 to S204.

In step S201, prohibition marking lines are determined based on lane-level data.

In some embodiments, harbor-style parking lanes, emergency lanes, evasion lanes, non-motorized vehicle lanes, and lane turning signs in the lane-level data are deleted. Longitudinal prohibition marking lines in the prohibition marking lines are screened out, and the longitudinal prohibition marking line may also be referred to as a boundary line of same-direction lanes. The lane-level data may be derived from data in the electronic map.

FIG. 5 shows a schematic diagram of longitudinal prohibition marking lines, as shown in FIG. 5, in some embodiments, the longitudinal prohibition marking lines may include a solid line (also referred to as a single solid line), a double solid line, and a dotted-solid combination line. Colors of the solid line, the double solid line, and the dotted-solid combination line may be either white or yellow, so the longitudinal prohibition marking lines may include such as a white solid line, a yellow solid line, a white double solid line, a yellow double solid line, a white dotted-solid combination line, and a yellow dotted-solid combination line.

Therefore, in embodiments of the present disclosure, a solid line, a double solid line, and a dotted-solid combination line in a road are determined based on the lane-level data.

In step S202, a first lane group corresponding to a longitudinal prohibition marking line included in the prohibition marking lines is determined.

In some embodiments, at least one first lane in a direction perpendicular to a direction of the longitudinal prohibition marking line is determined. A set formed by all the first lanes is determined as the first lane group, and a length of the first lane is equal to a length of the longitudinal prohibition marking line. The first lane group may also be referred to as an aggregated lane group.

The present disclosure provides a schematic diagram of another road, as shown in FIG. 6, there is a prohibition marking line (a dotted-solid combination line) at a boundary line between two adjacent roads, and the first lane group includes 5 lines perpendicular to a direction of the dotted-solid combination line. The 5 lanes are lane 1, lane 2, lane 3, lane 4, and lane 5, respectively. The 5 lanes form the first lane group, and a length of each lane in the first lane group is equal to a length of the dotted-solid combination line.

In step S203, a second lane group and a third lane group adjacent to the first lane group is determined based on the first lane group and the longitudinal prohibition marking line.

In some embodiments, the second lane group is obtained by tracing from a start position of the longitudinal prohibition marking line back to an opposite direction of the longitudinal prohibition marking line. The number of the second lane groups is at least one.

In some embodiments, the second lane group includes one or more second lanes that are perpendicular to the direction of the longitudinal prohibition marking line. One end point of the second lane included in the second lane group is located at the start position of the longitudinal prohibition marking line. The second lane group may also be referred to as a front lane group.

In some embodiments, the third lane group is obtained by tracing from a final position of the longitudinal prohibition marking line to a direction of the longitudinal prohibition marking line. The number of the third lane groups is at least one.

In some embodiments, the third lane group includes one or more third lanes that are perpendicular to the direction of the longitudinal prohibition marking line. One end point of the third lane included in the third lane group is located at the final position of the longitudinal prohibition marking line. The third lane group may also be referred to as a subsequent lane group.

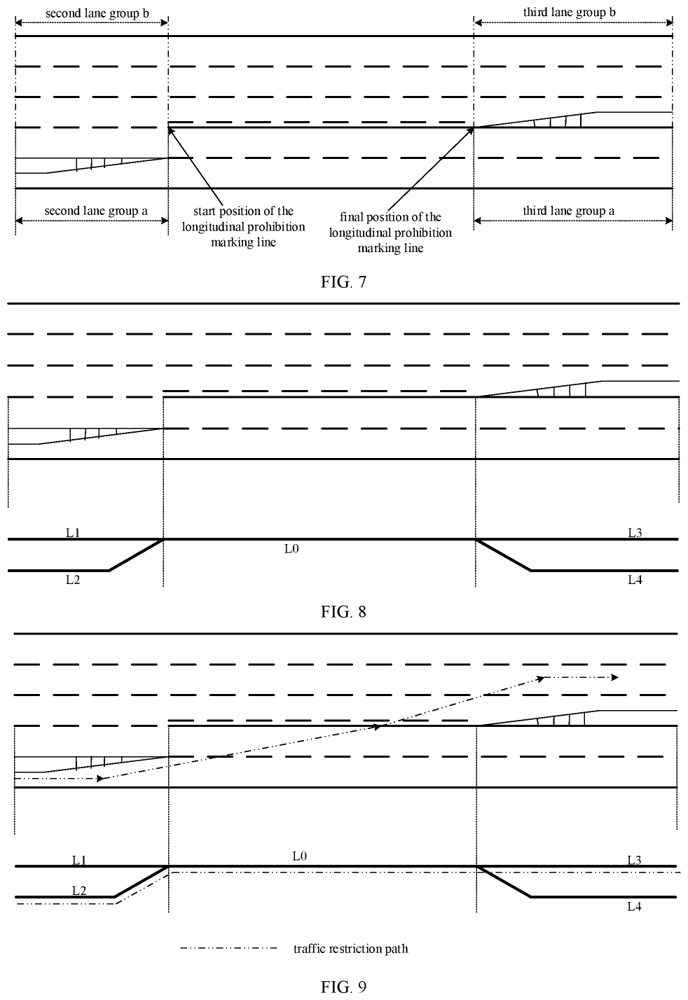

For the road shown in FIG. 6, a schematic diagram of the second lane group and the third lane group is shown in FIG. 7, where there are two second lane groups, i.e., a second lane group a and a second lane group b, and two third lane groups, i.e., a third lane group a and a third lane group b.

In step S204, whether a path-level traffic restriction exists is determined based on a connectivity of the first lane group with the second lane group and the third lane group.

In some embodiments, at least one first lane included in the first lane group is determined. At least one second lane included in the second lane group is determined. Whether the path-level traffic restriction exists between the first lane group and the second lane group is determined based on a connectivity between the first lane and the second lane.

In some alternative implementations, it is determined that a non-connectivity exists between the first lane and the second lane if a prohibition marking line between the first lane and the second lane is a solid line. It is determined based on the non-connectivity that a path from the first lane group to the second lane group and a path from the second lane group to the first lane group are impassable paths.

The non-connectivity may indicate that vehicles on the lanes at both sides of the prohibition marking line cannot cross the prohibition marking line. That is, any first lane in the first lane group cannot drive through the prohibition marking line to any second lane in the second lane group, and any second lane in the second lane group cannot drive through the prohibition marking line to any first lane in the first lane group.

In some other alternative implementations, it is determined that a semi-connectivity exists between the first lane and the second lane if a prohibition marking line between the first lane and the second lane is a dotted-solid combination line. It is determined based on the semi-connectivity that an impassable path exists from the second lane group adjacent to the solid line of the prohibition marking line to the first lane group adjacent to the dotted line of the prohibition marking line. Or, it is determined based on the semi-connectivity that an impassable path exists from the second lane group adjacent to the dotted line of the prohibition marking line to the first lane group adjacent to the solid line of the prohibition marking line.

The semi-connectivity may indicate that vehicles on the lane at one side of the prohibition marking line (close to a side of the dotted line of the dotted-solid combination line) may cross the prohibition marking line, and vehicles at the other side of the prohibition marking line (close to a side of the solid line of the dotted-solid combination line) cannot cross the prohibition marking line. As an example, if the first lane group is adjacent to the dotted line of the dotted-solid combination line, and the second lane group is adjacent to the solid line of the dotted-solid combination line, vehicles on any second lane in the second lane group cannot drive through the prohibition marking line to any first lane in the first lane group.

The impassable path between the first lane group and the second lane group is described above, and an impassable path between the first lane group and the third lane group will be described below.

In some embodiments, at least one first lane included in the first lane group is determined. At least one third lane included in the third lane group is determined. Whether the path-level traffic restriction exists between the first lane group and the third lane group is determined based on the connectivity between the first lane and the third lane.

In some alternative implementations, it is determined that a non-connectivity exists between the first lane and the third lane if a prohibition marking line between the first lane and the third lane is a solid line. It is determined based on the non-connectivity that a path from the first lane group to the third lane group and a path from the third lane group to the first lane group are impassable paths.

The non-connectivity may indicate that vehicles on the lanes at both sides of the prohibition marking line cannot cross the prohibition marking line. That is, any first lane in the first lane group cannot drive through the prohibition marking line to any third lane in the third lane group, and any third lane in the third lane group cannot drive through the prohibition marking line to any first lane in the first lane group.

In some other alternative implementations, it is determined that a semi-connectivity exists between the first lane and the third lane if a prohibition marking line between the first lane and the third lane is a dotted-solid combination line. It is determined based on the semi-connectivity that an impassable path exists from the third lane group adjacent to the solid line of the prohibition marking line to the first lane group adjacent to the dotted line of the prohibition marking line. Or, it is determined based on the semi-connectivity that an impassable path exists from the first lane group adjacent to the solid line of the prohibition marking line to the third lane group adjacent to the dotted line of the prohibition marking line.

The semi-connectivity may indicate that vehicles on the lane at one side of the prohibition marking line (close to a side of the dotted line of the dotted-solid combination line) may cross the prohibition marking line, and vehicles on the other side of the prohibition marking line (close to a side of the solid line of the dotted-solid combination line) cannot cross the prohibition marking line. As an example, if the first lane group is adjacent to the dotted line of the dotted-solid combination line, and the third lane group is adjacent to the solid line of the dotted-solid combination line, vehicles on any third lane in the third lane group cannot drive through the prohibition marking line to any first lane in the first lane group.

In the above, the determination of the impassable path between the first lane group and the second lane group and the impassable path between the first lane group and the third lane group are described. It may be further determined whether there is a path-level traffic restriction based on the above determination result. In a specific implementation, it is determined that the path-level traffic restriction exists between the second lane group and the third lane group if an impassable path exists between the first lane group and at least one of the second lane group and the third lane group. As an example, the path-level traffic restriction exists between the second lane group and the third lane group if a passable path exists between the first lane group and the second lane group, and an impassable path exists between the first lane group and the third lane group. That is, a path on which the vehicle cannot travel is from the second lane included in the second lane group to the third lane included in the third lane group via the first lane included in the first lane group. The path-level traffic restriction existing between the second lane group and the third lane group is that a path from the second lane included in the second lane group to the third lane included in the third lane group via the first lane included in the first lane group is an impassable path.

Taking a road shown in FIG. 6 and lane groups shown in FIG. 7 as an example, a road connection structure shown in FIG. 8 is obtained based on the road shown in FIG. 6 and the lane groups shown in FIG. 7. As shown in FIG. 8, a link L1 and a link L2 belong to the second lane group, a link L0 belongs to the first lane group, and a link L3 and a link L4 belong to the third lane group. Since the first lane group is adjacent to the solid line of the dotted-solid combination line, and the link L3 in the third lane group is adjacent to the dotted line of the dotted-solid combination line, any first lane in the first lane group cannot drive cross the dotted-solid combination line to the link L3. Therefore, a path sequentially formed by the link L2, the link L0, and the link L3 is a traffic restriction path. A schematic diagram of the traffic restriction path is shown by a dot-dash line in FIG. 9.

The traffic restriction path determined by the traffic restriction identification method provided by embodiment of the present disclosure may be used to update or supplement path-level traffic restriction information in the electronic map.

The traffic restriction identification method, a traffic restriction identification apparatus, and an electronic device provided by embodiments of the present disclosure may be applied to the scenario of path planning or path navigation. A path is planned for a user according to the initial place and the destination input by the user, and the planned path does not include the traffic restriction path determined by using the traffic restriction identification method provided by embodiments of the present disclosure.

In embodiments of the present disclosure, the road is divided into three types of lane groups by identifying the prohibition marking lines in the lane-level data of the electronic map, it is determined whether the connectivity of a road between two adjacent lane groups exists according to the connectivity among the three types of lane groups, and the path-level traffic restriction is determined according to the connectivity of the road between two adjacent lane groups. In this way, the path-level traffic restriction may be obtained by performing dimension reduction processing on the lane-level data in real time. The traffic restriction identification method provide by embodiments of the present disclosure has the characteristics of real-time and automatic processing as compared with updating and maintaining the path-level traffic restriction information manually and regularly in the related art, so it may improve the efficiency of traffic restriction identification.

An embodiment of the present disclosure further provides a traffic restriction identification apparatus. A schematic diagram of a traffic restriction identification apparatus is shown in FIG. 10. The apparatus includes a prohibition marking line determining module 401, a lane group determining module 402, and a traffic restriction determining module 403.

The prohibition marking line determining module 401 is configured to determine prohibition marking lines based on lane-level data.

The lane group determining module 402 is configured to determine a first lane group corresponding to a longitudinal prohibition marking line included in the prohibition marking lines; and determine a second lane group and a third lane group adjacent to the first lane group based on the first lane group and the longitudinal prohibition marking line.

The traffic restriction determining module 403 is configured to determine whether a path-level traffic restriction exists based on a connectivity of the first lane group with the second lane group and the third lane group.

In some embodiments, the lane group determining module 402 is configured to determine at least one first lane in a direction perpendicular to a direction of the longitudinal prohibition marking line, and determine a set formed by all the first lanes as the first lane group. A length of the first lane is equal to a length of the longitudinal prohibition marking line.

In some embodiments, the lane group determining module 402 is configured to trace from a start position of the longitudinal prohibition marking line back to an opposite direction of the longitudinal prohibition marking line to obtain the second lane group. The number of the second lane groups is at least one.

In some embodiments, the lane group determining module 402 is configured to trace from a final position of the longitudinal prohibition marking line to a direction of the longitudinal prohibition marking line to obtain the third lane group. The number of the third lane groups is at least one.

In some embodiments, the traffic restriction determining module 403 is configured to determine at least one first lane included in the first lane group, determine at least one second lane included in the second lane group, and determine whether the path-level traffic restriction exists between the first lane group and the second lane group based on a connectivity between the first lane and the second lane.

In some embodiments, the traffic restriction determining module 403 is configured to determine that a non-connectivity between the first lane and the second lane exists if a prohibition marking line between the first lane and the second lane is a solid line, and determine that a path from the first lane group to the second lane group and a path from the second lane group to the first lane group are impassable paths based on the non-connectivity.

In some embodiments, the traffic restriction determining module 403 is configured to determine that a semi-connectivity between the first lane and the second lane exists if a prohibition marking line between the first lane and the second lane is a dotted-solid combination line, determine that an impassable path exists from the second lane group adjacent to the solid line of the prohibition marking line to the first lane group adjacent to the dotted line of the prohibition marking line based on the semi-connectivity, or determine that an impassable path exists from the second lane group adjacent to the dotted line of the prohibition marking line to the first lane group adjacent to the solid line of the prohibition marking line based on the semi-connectivity.

In some embodiments, the traffic restriction determining module 403 is configured to determine at least one first lane included in the first lane group, determine at least one third lane included in the third lane group, and determine whether the path-level traffic restriction exists between the first lane group and the third lane group based on the connectivity between the first lane and the third lane.

In some embodiments, the traffic restriction determining module 403 is configured to determine that a non-connectivity between the first lane and the third lane exists if a prohibition marking line between the first lane and the third lane is a solid line, and determine that a path from the first lane group to the third lane group and a path from the third lane group to the first lane group are impassable paths based on the non-connectivity.

In some embodiments, the traffic restriction determining module 403 is configured to determine that a semi-connectivity between the first lane and the third lane exists if a prohibition marking line between the first lane and the third lane is a dotted-solid combination line, determine that an impassable path exists from the third lane group adjacent to the solid line of the prohibition marking line to the first lane group adjacent to the dotted line of the prohibition marking line based on the semi-connectivity, or determine that an impassable path exists from the first lane group adjacent to the solid line of the prohibition marking line to the third lane group adjacent to the dotted line of the prohibition marking line based on the semi-connectivity.

In some embodiments, the traffic restriction determining module 403 is configured to determine that the path-level traffic restriction exists between the second lane group and the third lane group if an impassable path exists between the first lane group and at least one of the second lane group and the third lane group, and the path-level traffic restriction existing between the second lane group and the third lane group is that a path from the second lane included in the second lane group to the third lane included in the third lane group via the first lane included in the first lane group is an impassable path.

According to embodiments of the present disclosure, the present disclosure also provides an electronic device, a readable storage medium, and a computer program product.

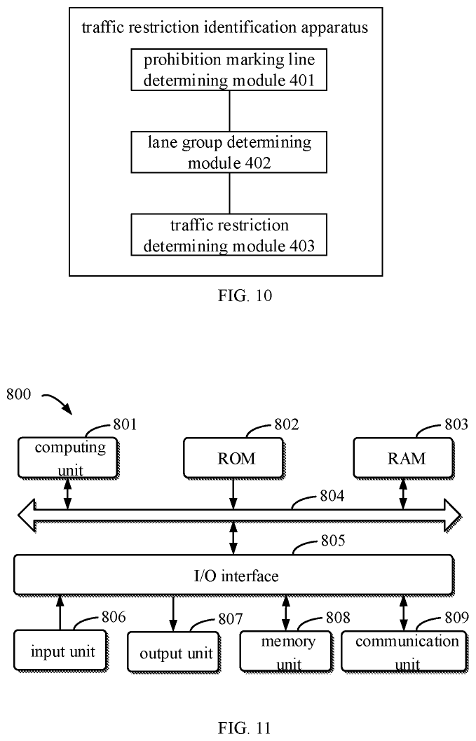

FIG. 11 is a block diagram showing an example electronic device 800 that may be used to implement embodiments of the present disclosure. In some embodiments, the electronic device 800 may implement the traffic restriction identification method provided by embodiments of the present application by running a computer program. For example, the computer program may be a native program or software module in an operating system. The computer program may be a native application (APP), that is, a program that needs to be installed in the operating system to run. The computer program may also be a small program, that is, a program that may be run only by downloading it into the browser environment. The computer program may also be a small program that may be embedded in any APP. In a word, the above-mentioned computer program may be any form of application, module or plug-in.

In practical applications, the electronic device 800 may be an independent physical server, a server cluster or a distributed system composed of multiple physical servers, or a cloud server that provides basic cloud computing services such as cloud service, cloud database, cloud computing, cloud function, cloud storage, network service, cloud communication, middleware service, domain name service, security service, CDN, big data and artificial intelligence platform. A cloud technology refers to a hosting technology that integrates a series of resources, such as hardware, software, and network, in a wide area network or a local area network, and realizes the calculation, storage, processing, and sharing of data. The electronic device 800 may be a smart phone, a tablet computer, a notebook computer, a desktop computer, a smart speaker, a smart TV, a smart watch, etc., but is not limited thereto.

The electronic device is intended to represent various forms of digital computers, such as, a laptop computer, a desktop computer, a workstation, a personal digital assistant, a server, a blade server, a mainframe computer, and other suitable computers. The electronic device may also represent various forms of mobile device, such as a personal digital processor, a cellular phone, a smart phone, a wearable device, and other similar computing devices. Components shown herein, their connections and relationships, and their functions are only illustrative, and are not intended to limit the implementations of the present disclosure described and/or claimed herein.

As shown in FIG. 11, the electronic device 800 includes a computing unit 801 that can perform various appropriate actions and processes according to a computer program stored in a read-only memory (ROM) 802 or loaded from a memory unit 808 into a random access memory (RAM) 803. In the RAM 803, various programs and data required for the operation of the electronic device 800 may also be stored. The computing unit 801, the ROM 802, and the RAM 803 are connected to each other via a bus 804. An input/output (I/O) interface 805 is also connected to the bus 804.

A plurality of components in the electronic device 800 are connected to the I/O interface 805, including an input unit 806, such as a keyboard, and a mouse; an output unit 807, such as various types of displays, and speakers; a memory unit 808, such as a magnetic disk, and an optical disk; and a communication unit 809, such as a network card, a modulator-demodulator, and a wireless communication transceiver. The communication unit 809 allows the electronic device 800 to exchange information/data with other devices via a computer network such as Internet and/or various telecommunications networks.

The computing unit 801 may be various generic and/or specific processing assemblies with processing and computational capabilities. Some examples of the computing unit 801 include, but are not limited to, central processing units (CPUs), graphics processing units (GPUs), various specific artificial intelligence (AI) computing chips, various computing units that run machine learning model algorithms, digital signal processors (DSPs), and any appropriate processors, controllers, and microcontrollers. The computing unit 801 is configured to execute the various methods and processes described above, for example traffic restriction identification method. For example, in some embodiments, the traffic restriction identification method may be implemented as a computer software program that is tangibly embodied on a machine-readable medium, such as the memory unit 808. In some embodiments, part or all of computer programs may be loaded and/or installed on the electronic device 800 via the ROM 802 and/or the communication unit 809. When a computer program is loaded into the RAM 803 and executed by the computing unit 801, one or more steps of the traffic restriction identification method described above may be executed. Alternatively, in other embodiments, the computing unit 801 may be configured to execute the traffic restriction identification method by any other suitable means (e.g., by means of a firmware).

Various implementations of the systems and techniques above-described herein may be implemented in digital electronic circuit systems, integrated circuit systems, field programmable gate arrays (FPGAs), application specific integrated circuits (ASICs), application specific standard products (ASSPs), system-on-chip (SOC) systems, load programmable logic devices (CPLDs), computer hardware, firmware, software, and/or combinations thereof. These various embodiments may include being implemented in one or more computer programs executable and/or interpretable on a programmable system including at least one programmable processor. The programmable processor may be a specific or generic programmable processor that may receive data and instructions from a storage system, at least one input device, and at least one output device, and transmit data and instructions to the storage system, the at least one input device, and the at least one output device.

Program codes for implementing the traffic restriction identification method in the present disclosure may be written in one or more programming languages in any combination. These program codes may be provided to a processor or a controller of a generic computer, a specific computer or other programmable data processing devices, such that the program codes, when executed by the processor or the controller, causes the functions/operations specified in the flowcharts and/or block diagrams to be implemented. The program codes may be entirely executed on a machine, partly executed on the machine, partly executed on the machine and partly executed on a remote machine as a stand-alone software package, or entirely executed on the remote machine or a server.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), a fiber optic, a portable compact disk read only memory (CD-ROM), an optical storage device, a magnetic storage device, or any suitable combination of the foregoing.

To provide interaction with a user, the systems and techniques described herein may be implemented on a computer having a display apparatus (e.g., a cathode ray tube (CRT) or a liquid crystal display (LCD) monitor) for displaying information to the user; and a keyboard and a pointing apparatus (e.g., a mouse or a trackball) through which the user can provide an input to the computer. Other kinds of apparatuses can also be used to provide interaction with the user; for example, a feedback provided to the user can be any form of sensory feedback (e.g., a visual feedback, an auditory feedback, or a tactile feedback); and the input from the user may be received in any form (including acoustic input, voice input, or tactile input).

The systems and techniques described herein can be implemented in a computing system including a back-end component (e.g., as a data server), a computing system including a middleware component (e.g., an application server), a computing system including a front-end component (e.g., a user computer having a graphical user interface or a web browser through which a user may interact with implementations of the systems and techniques described herein), or a computing system that includes any combination of the back-end component, the middleware component, or the front-end component. The components of the system may be connected with each other via any form or medium of digital data communication (e.g., a communication network). An example of the communication network includes a local area network (LAN), a wide area network (WAN), and the Internet.

The computer system may include a client and a server. The client and the server are generally remote from each other and usually interact with each other through a communication network. A relationship of the client and the server is generated by a computer program that runs on a corresponding computer and has a client-server relationship with each other. The server can be a cloud server, a server for a distributed system, or a server combined with a blockchain.

It can be understood that various forms of flowcharts shown above can be used to reorder, add, or remove steps. For example, the steps described in the present disclosure may be performed in parallel, sequentially, or in a different order. There is no limitation hereto as long as the desired results of the technical solutions disclosed herein can be realized.

The above-mentioned specific embodiments do not constitute a limitation on the protection scope of the present disclosure. It can be understood by those skilled in the art that various modifications, combinations, sub-combinations and substitutions can be made depending on design requirements and other factors. Any modifications, equivalent replacements, and improvements made within the spirit and principle of the present disclosure should be included within the protection scope of the present disclosure.

1. A traffic restriction identification method, comprising:
determining prohibition marking lines based on lane-level data;
determining a first lane group corresponding to a longitudinal prohibition marking line included in the prohibition marking lines;
determining a second lane group and a third lane group adjacent to the first lane group based on the first lane group and the longitudinal prohibition marking line; and
determining whether a path-level traffic restriction exists based on a connectivity of the first lane group with the second lane group and the third lane group.

2. The method of claim 1, wherein determining the first lane group corresponding to the longitudinal prohibition marking line included in the prohibition marking lines comprises:
determining at least one first lane in a direction perpendicular to a direction of the longitudinal prohibition marking line; and
determining a set formed by all the first lanes as the first lane group, wherein a length of the first lane is equal to a length of the longitudinal prohibition marking line.

3. The method of claim 1, wherein determining the second lane group and the third lane group adjacent to the first lane group based on the first lane group and the longitudinal prohibition marking line comprises:
obtaining the second lane group by tracing from a start position of the longitudinal prohibition marking line back to an opposite direction of the longitudinal prohibition marking line;
obtaining the third lane group by tracing from a final position of the longitudinal prohibition marking line to a direction of the longitudinal prohibition marking line,
wherein the number of the second lane groups is at least one, and the number of the third lane groups is at least one.

4. (canceled)

5. The method of claim 1, wherein determining whether the path-level traffic restriction exists based on the connectivity of the first lane group with the second lane group and the third lane group comprises:
determining at least one first lane included in the first lane group;
determining at least one second lane included in the second lane group; and
determining whether the path-level traffic restriction exists between the first lane group and the second lane group based on a connectivity between the first lane and the second lane.

6. The method of claim 5, wherein determining whether the path-level traffic restriction exists between the first lane group and the second lane group based on the connectivity between the first lane and the second lane comprises:
determining that a non-connectivity between the first lane and the second lane exists if a prohibition marking line between the first lane and the second lane is a solid line; and
determining that a path from the first lane group to the second lane group and a path from the second lane group to the first lane group are impassable paths based on the non-connectivity.

7. The method of claim 5, wherein determining whether the path-level traffic restriction exists between the first lane group and the second lane group based on the connectivity between the first lane and the second lane comprises:
determining that a semi-connectivity between the first lane and the second lane exists if a prohibition marking line between the first lane and the second lane is a dotted-solid combination line;
determining that an impassable path exists from the second lane group adjacent to a solid line of the prohibition marking line to the first lane group adjacent to a dotted line of the prohibition marking line based on the semi-connectivity; or
determining that an impassable path exists from the first lane group adjacent to the solid line of the prohibition marking line to the second lane group adjacent to the dotted line of the prohibition marking line based on the semi-connectivity.

8. The method of claim 1, wherein determining whether the path-level traffic restriction exists based on the connectivity of the first lane group with the second lane group and the third lane group comprises:
determining at least one first lane included in the first lane group;
determining at least one third lane included in the third lane group; and
determining whether the path-level traffic restriction exists between the first lane group and the third lane group based on the connectivity between the first lane and the third lane.

9. The method of claim 8, wherein determining whether the path-level traffic restriction exists between the first lane group and the third lane group based on the connectivity between the first lane and the third lane comprises:
determining that a non-connectivity between the first lane and the third lane exists if a prohibition marking line between the first lane and the third lane is a solid line; and
determining that a path from the first lane group to the third lane group and a path from the third lane group to the first lane group are impassable paths based on the non-connectivity.

10. The method of claim 8, wherein determining whether the path-level traffic restriction exists between the first lane group and the third lane group based on the connectivity between the first lane and the third lane comprises:
determining that a semi-connectivity between the first lane and the third lane exists if a prohibition marking line between the first lane and the third lane is a dotted-solid combination line;
determining that an impassable path exists from the third lane group adjacent to a solid line of the prohibition marking line to the first lane group adjacent to a dotted line of the prohibition marking line based on the semi-connectivity; or
determining that an impassable path exists from the first lane group adjacent to the solid line of the prohibition marking line to the third lane group adjacent to the dotted line of the prohibition marking line based on the semi-connectivity.

11. The method of claim 1, wherein determining whether the path-level traffic restriction exists based on the connectivity of the first lane group with the second lane group and the third lane group comprises:
determining that the path-level traffic restriction exists between the second lane group and the third lane group if an impassable path exists between the first lane group and at least one of the second lane group and the third lane group;
wherein the path-level traffic restriction existing between the second lane group and the third lane group is that a path from the second lane included in the second lane group to the third lane included in the third lane group via the first lane included in the first lane group is an impassable path.

12. (canceled)

13. An electronic device, comprising:
at least one processor; and
a memory communicatively connected to the at least one processor; wherein
the memory is stored with instructions executable by the at least one processor, and the instructions, when executed by the at least one processor, cause the at least one processor to:
determine prohibition marking lines based on lane-level data;
determine a first lane group corresponding to a longitudinal prohibition marking line included in the prohibition marking lines;
determine a second lane group and a third lane group adjacent to the first lane group based on the first lane group and the longitudinal prohibition marking line; and
determine whether a path-level traffic restriction exists based on a connectivity of the first lane group with the second lane group and the third lane group.

14. A non-transitory computer-readable storage medium having stored therein computer instructions that cause a computer to:
determine prohibition marking lines based on lane-level data;
determine a first lane group corresponding to a longitudinal prohibition marking line included in the prohibition marking lines;
determine a second lane group and a third lane group adjacent to the first lane group based on the first lane group and the longitudinal prohibition marking line; and
determine whether a path-level traffic restriction exists based on a connectivity of the first lane group with the second lane group and the third lane group.

15. (canceled)

16. The electronic device of claim 13, wherein the at least one processor is further configured to:
determine at least one first lane in a direction perpendicular to a direction of the longitudinal prohibition marking line; and determine a set formed by all the first lanes as the first lane group, wherein a length of the first lane is equal to a length of the longitudinal prohibition marking line.

17. The electronic device of claim 13, wherein the at least one processor is further configured to:
obtain the second lane group by tracing from a start position of the longitudinal prohibition marking line back to an opposite direction of the longitudinal prohibition marking line; and
obtain the third lane group by tracing from a final position of the longitudinal prohibition marking line to a direction of the longitudinal prohibition marking line,
wherein the number of the second lane groups is at least one, and the number of the third lane groups is at least one.

18. The electronic device of claim 13, wherein the at least one processor is further configured to:
determine at least one first lane included in the first lane group;
determine at least one second lane included in the second lane group; and
determine whether the path-level traffic restriction exists between the first lane group and the second lane group based on a connectivity between the first lane and the second lane.

19. The electronic device of claim 18, wherein the at least one processor is further configured to:
determine that a non-connectivity between the first lane and the second lane exists if a prohibition marking line between the first lane and the second lane is a solid line; and
determine that a path from the first lane group to the second lane group and a path from the second lane group to the first lane group are impassable paths based on the non-connectivity.

20. The electronic device of claim 18, wherein the at least one processor is further configured to:
determine that a semi-connectivity between the first lane and the second lane exists if a prohibition marking line between the first lane and the second lane is a dotted-solid combination line;
determine that an impassable path exists from the second lane group adjacent to a solid line of the prohibition marking line to the first lane group adjacent to a dotted line of the prohibition marking line based on the semi-connectivity; or
determine that an impassable path exists from the first lane group adjacent to the solid line of the prohibition marking line to the second lane group adjacent to the dotted line of the prohibition marking line based on the semi-connectivity.

21. The electronic device of claim 13, wherein the at least one processor is further configured to:
determine at least one first lane included in the first lane group;
determine at least one third lane included in the third lane group; and
determine whether the path-level traffic restriction exists between the first lane group and the third lane group based on the connectivity between the first lane and the third lane.

22. The electronic device of claim 21, wherein the at least one processor is further configured to:
determine that a non-connectivity between the first lane and the third lane exists if a prohibition marking line between the first lane and the third lane is a solid line; and
determine that a path from the first lane group to the third lane group and a path from the third lane group to the first lane group are impassable paths based on the non-connectivity.

23. The electronic device of claim 21, wherein the at least one processor is further configured to:
determine that a semi-connectivity between the first lane and the third lane exists if a prohibition marking line between the first lane and the third lane is a dotted-solid combination line;
determine that an impassable path exists from the third lane group adjacent to a solid line of the prohibition marking line to the first lane group adjacent to a dotted line of the prohibition marking line based on the semi-connectivity; or
determine that an impassable path exists from the first lane group adjacent to the solid line of the prohibition marking line to the third lane group adjacent to the dotted line of the prohibition marking line based on the semi-connectivity.
